(19) United States
(12) Patent Application Publication
(10) Pub. No.: US 2014/0004799 A1
(43) Pub. Date: Jan. 2, 2014

(54) COMMUNICATION METHOD, COMMUNICATION DEVICE, AND COMPUTER PROGRAM PRODUCT

(71) Applicant: Kabushiki Kaisha Toshiba, Tokyo (JP)

(72) Inventor: Masaya Masuda, Fussa-shi (JP)

(73) Assignee: KABUSHIKI KAISHA TOSHIBA, Tokyo (JP)

(21) Appl. No.: 14/014,015

(22) Filed: Aug. 29, 2013

Related U.S. Application Data
(63) Continuation of application No. PCT/JP2013/057943, filed on Mar. 13, 2013.

(30) Foreign Application Priority Data
Jun. 28, 2012 (JP) 2012-145220

(51) Int. Cl. H04W 52/02

(52) U.S. Cl. CPC H04W 52/0225
USPC 455/41.2

(57) ABSTRACT

According to one embodiment, a communication method is performed by a communication device comprising an output module configured to output output information. The method includes: controlling communication between the communication device and an external device configured to output output information; detecting a positional relationship between the communication device and the external device; and switching, in accordance with the positional relationship, a processing to be performed from one of a first processing configured to output output information from the output module, a second processing configured to request the external device to output output information, and a third processing configured to output output information from the output module and to request the external device to output output information, to other one of the first processing, the second processing, and the third processing.

### CROSS-REFERENCE TO RELATED APPLICATIONS

This application is a continuation of PCT international application Ser. No. PCT/JP2013/057943, filed Mar. 13, 2013, incorporated herein by reference, and which is based upon and claims the benefit of priority from Japanese Patent Application No. 2012-145220, filed on Jun. 28, 2012, the entire contents of which are incorporated herein by reference.

### FIELD

Embodiments described herein relate generally to a communication method, a communication device, and a computer program product.

### BACKGROUND

There has been known technology in which a user is notified by an alarm, etc., when a plurality of devices such as amain device and a sub device are separated away from each other.

However, a user may not effectively be notified by the conventional technology because the user is notified by one of the devices (e.g., the main device) in accordance with the distance between the devices.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a communication system according to an embodiment;

FIG. 2 is an exemplary block diagram of a configuration of a wireless communication device in the embodiment;

FIG. 3 is an exemplary schematic diagram illustrating a wireless communication method in the embodiment;

FIG. 4 is an exemplary diagram of a control table in the embodiment;

FIG. 5 is an exemplary diagram of a table for specifying a control table corresponding to a type of an application, in the embodiment;

FIG. 6 is an exemplary diagram of a determination table for determining a control table corresponding to a type of an event, in the embodiment; and

FIG. 7 is an exemplary flowchart of a communication processing in the embodiment.

### DETAILED DESCRIPTION

In general, according to one embodiment, a communication method is performed by a communication device comprising an output module configured to output output information. The method comprises: controlling communication between the communication device and an external device configured to output output information; detecting a positional relationship between the communication device and the external device; and switching, in accordance with the positional relationship, a processing to be performed from one of a first processing configured to output output information from the output module, a second processing configured to request the external device to output output information, and a third processing configured to output output information from the output module and to request the external device to output output information, to other one of the first processing, the second processing, and the third processing.

In the following, with reference to the attached drawings, a communication device according to an embodiment is explained in details.

According to the Bluetooth (registered trademark) v4.0, LE (low energy) is defined for a wireless communication method. The LE is defined so as to realize a long drive time of a device when a button battery is used. Using the LE, proximity can be detected while connection has generally been established as well as low power consumption is maintained.

A communication device according to the embodiment uses for example a technique of proximity detection and LE link receiving benefit of low power consumption, so as to switch a control method for a processing (operation) of output information in accordance with a proximity state of the communication device with respect to a target communication device (external device). The output information is, for example, voice, audio output, ring and vibration of alarm. Here, the notification of the output information is not limited to sound. For example, a user can be notified of the output information by vibration.

The communication device of the present embodiment switches between whether to output the sound from an output module of the communication device or from the external device, in accordance with the proximity state, for example. If a user is nearby, the communication device of the present embodiment plays the sound at a normal volume. Then, if a user who is holding the external device is moving away from the communication device, the communication device increases the volume. If a user is at greater than or equal to a predetermined distance away from the communication device, the communication device makes the external device to play the sound.

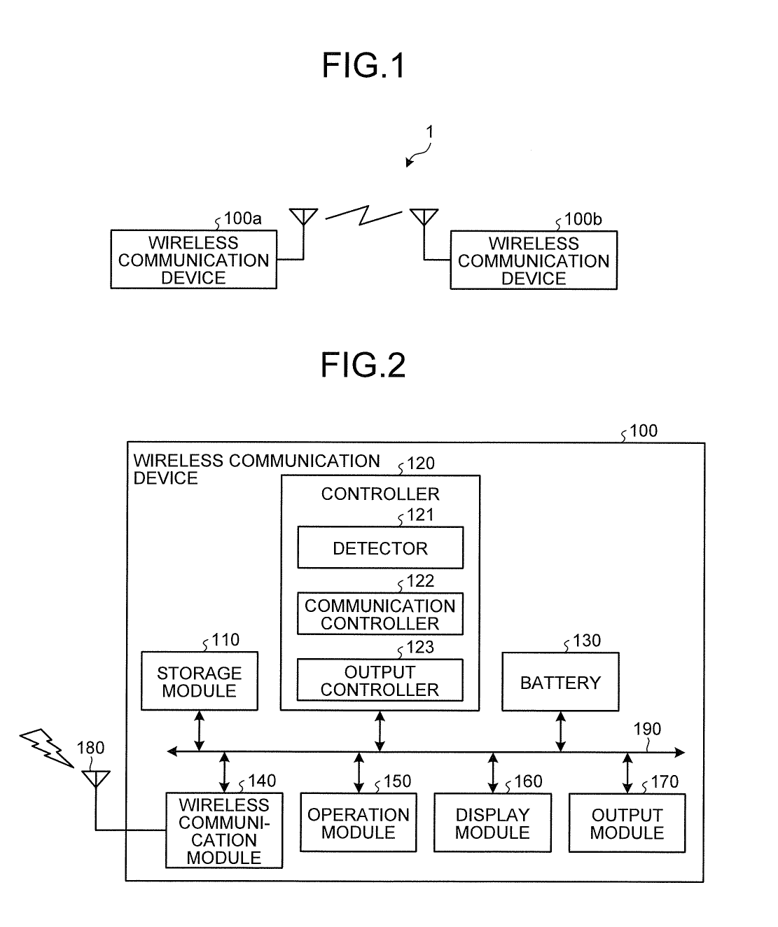

FIG. 1 is a conceptual diagram illustrating one example of a communication system 1 according to the present embodiment. As illustrated in FIG. 1, the communication system 1 comprises a wireless communication device 100a and a wireless communication device 100b, as communication devices.

Wireless communication devices 100a, 100b are for example a mobile phone, a personal computer (PC), a tablet terminal, a portable information terminal, or the like. The wireless communication devices 100a, 100b perform wireless communication therebetween. Here, the wireless communication complies a communication protocol of the Bluetooth (registered trademark), for example. However, the communication protocol applicable is not limited to the Bluetooth (registered trademark), and other wireless communication protocol may be used.

The wireless communication devices 100a, 100b may have the same configuration with each other. In the following, if it is unnecessary to distinguish these two devices, the devices are referred merely as a wireless communication device 100. Here, the number of wireless communication device 100 provided to the communication system 1 is not limited to two, and wireless communication device 100 of greater than or equal to three in number may be provided.

FIG. 2 is a block diagram illustrating one example of a configuration of the wireless communication device 100. As illustrated in FIG. 2, the wireless communication device 100 comprises a storage module 110, a controller 120, a battery 130, a wireless communication module 140, an operation module 150, a display module 160, an output module 170, an antenna 180, and a bus 190.

The wireless communication device 100 has a communication function mainly for wireless transmission of data stored in the storage module 110 via the wireless communication module 140 under the control of the controller 120 and for receiving of data from a wireless communication target device.

The storage module 110 stores therein various programs to be executed by the controller 120, various information required for predetermined processing, various data files, and/or the like. For example, the storage module 110 stores therein a control table (details thereof will be described later) for determining a control method for the output information of the wireless communication device and the external device (hereinafter, referred to as a target device) which is a communication target.

The storage module 110 can be configured by various generally-used storage medium such as a hard disk drive (HDD), an optical disk, a memory card, and a random access memory (RAM).

The battery 130 is for example a capacitor, and has a function of accumulating supplied power. The wireless communication device 100 is driven by the power from the battery 130.

The wireless communication module 140 transmits and receives radio waves via the antenna 180 in accordance with the control of the controller 120 (communication controller 122 described later), to perform wireless communication with other communication devices. The wireless communication module 140 performs short-distance wireless communication with respect to other communication devices.

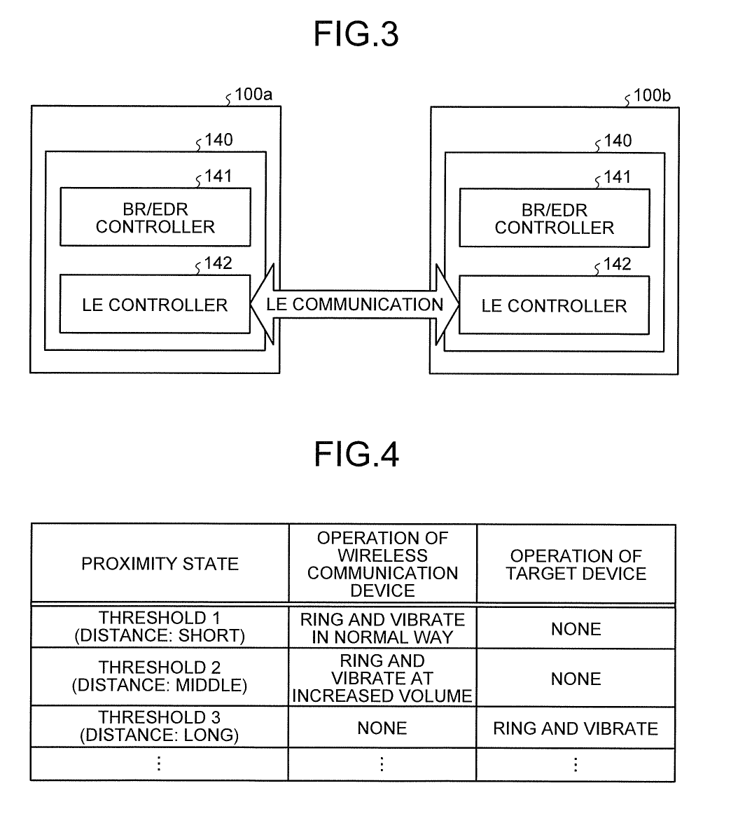

In the following, an example of a configuration of the wireless communication module 140 that uses the Bluetooth (registered trademark) as a communication protocol is explained. FIG. 3 is a conceptual diagram illustrating an example of a wireless communication method according to the present embodiment.

The wireless communication module 140 comprises a basic rate (BR)/enhanced data rate (EDR) controller 141 and an LE controller 142.

The BR/EDR controller 141 is a communication controller which operates in accordance with a BR and EDR communication specification (communication method). The LE controller 142 is a communication controller which operates in accordance with an LE communication specification (communication method).

Here, one of the wireless communication devices 100 which communicate with one another (for example, the wireless communication device 100b held by a user) may only be configured to be provided with the LE controller 142. In such configuration, the proximity detection and the wireless communication can be realized at least by the LE link (LE communication).

Referring back to FIG. 2, the operation module 150 is an operation input module at which a user inputs operation into the wireless communication device 100. The operation module 150 can be configured by, for example, a keyboard, a touch panel, and/or the like. The operation module 150 inputs the user's operation input to the wireless communication device 100 as predetermined electronic signals. Here, the operation module 150 is not limited to be provided with the keyboard and the touch panel, and for example, a signal receiver that receives a signal from an external remote controller to which the user performs operation input may be provided.

The display module 160 is a display module such as, for example, a liquid crystal display or a self-luminous display, and has a function of displaying images.

The output module 170 outputs output information as ring and vibration or sound output. The output module 170 may be configured by, for example, a speaker. On the other hand, if the output information is output as displaying of images, the display module 160 can be used instead of the output module 170.

The bus 190 connects configurations within the wireless communication device 100 with each other in a manner so that the configurations can communicate with one another.

The controller 120 controls the entire wireless communication device 100. The controller 120 is, for example, a central processing unit (CPU). The controller 120 executes, for example, predetermined processing in accordance with a program stored in the storage module 110. The controller 120 comprises a detector 121, a communication controller 122, and an output controller 123.

The detector 121 detects positional relationship between the wireless communication device 100 and the target device. For example, the detector 121 detects proximity state of the wireless communication device 100 with respect to the target device by radio wave intensity received by the wireless communication module 140. When the Bluetooth (registered trademark) is used as the communication protocol, the detector 121 may detect the proximity state with respect to the target device by using a proximity detecting method defined by the LE technology of the Bluetooth (registered trademark).

The detector 121 detects that, for example, a distance to the target device is short, far to some extent, or middle, by using a predetermined threshold 1 (first specified distance), a predetermined threshold 2 (second specified distance), and a predetermined threshold 3 (third specified distance) for distinguishing the proximity state (distance). Here, the number of thresholds used is not limited to three. That is to say, a threshold 4 (fourth specified distance) which is greater than the threshold 3 may be used so as to temporarily invalidate the outputting of the output information when the distance is greater than the threshold 4. Consequently, it becomes possible to avoid a situation in which the outputting of the sound is continued even when, for example, the distance between the wireless communication device 100 and the target device is separated away by a distance such that the wireless connection cannot be maintained or the wireless connection is disconnected.

The communication controller 122 controls the communication with respect to the target device. For example, the communication controller 122 controls the wireless communication module 140 so as to perform wireless communication with respect to the target device by sending and receiving radio waves via the antenna 180. When it becomes necessary to start the wireless connection, the communication controller 122 controls the wireless communication module 140 to establish the connection with the target device by a method defined by the Bluetooth (registered trademark) standard. Consequently, it becomes possible to send and receive data bi-directionally with respect to the target device. The wireless connection becomes necessary when, for example: a user instructs the wireless communication device 100 to establish wireless connection with the target device via the operation module 150; the wireless connection is to be performed in accordance with determination or the like of the controller 120; or the wireless communication device 100 receives a wireless connection request from the target device.

The output controller 123 switches a control method of a processing for outputting the output information, in accordance with the positional relationship (proximity state) detected by the detector 121. For example, in accordance with the proximity state, the output controller 123 switches a processing to be performed from one of a processing (first processing) in which the output information is output from the output module 170, a processing (second processing) in which the output information is output from the target device, and a processing (third processing) in which the output information is output from the output module 170 and from the target device, to other one of the first processing, the second processing, and the third processing.

FIG. 4 is a diagram illustrating one example of a control table which can be used by the output controller 123 to specify the control method. As illustrated in FIG. 4, the storage module 110 for example stores a control table in which a proximity state, an operation of a wireless communication device 100, and an operation of a target device are associated with one another.

In the example of FIG. 4, if the proximity state is less than or equal to the threshold 1, the output controller 123 performs controlling so that the wireless communication device 100 rings and vibrates in normal way whereas the target device does not ring and vibrate. If the proximity state is greater than the threshold 1 and less than or equal to the threshold 2, the output controller 123 performs controlling so that the first device rings and vibrates at an increased volume whereas the second device does not ring and vibrate. If the proximity state is greater than the threshold 2 and less than or equal to the threshold 3, the output controller 123 performs controlling so that the first device does not ring and vibrate whereas the second device rings and vibrates.

Although not illustrated in FIG. 4, the control table can be defined so as to perform a third processing in which both the operation of the wireless communication device 100 (first processing) and the operation of the target device (second processing) are performed.

FIG. 4 is an example of a control table usable for when the wireless communication device 100 is a mobile phone and the like capable of performing voice output, audio output, notifying, and ringing and vibrating, and for when the second device is a proximity notification device. Here, the proximity notification device is a device capable of detecting whether the proximity notification device is in proximity with the main device (wireless communication device 100), and notifying the main device of the detection result. For example, a user holds the proximity notification device at all times, and when the mobile phone is forgotten, a user can be notified that the mobile phone is forgotten by ringing and vibrating of the mobile phone or the proximity notification device.

According to the control table of FIG. 4, if the user holding the proximity notification device is near the wireless communication device 100, the voice output, the audio output, the notification, and/or the ringing and vibrating is performed at the wireless communication device 100 side, as usual. Then, if the user and the wireless communication device 100 are separated away from each other at a certain distance, the voice output, the audio output, the notification, and/or the ringing and vibrating is performed at the wireless communication device 100 side, at a volume of greater than the normal volume. If the user and the wireless communication device 100 are separated away from each other at a great distance, the voice reproduction, the notification, and/or the ringing and vibrating is performed at the proximity notification device side instead of the wireless communication device 100 side.

The processing performed in accordance with the control table of FIG. 4 is explained in detail. For example, a case in which the wireless communication device 100 is a device which outputs video and audio contents, such as a digital television, and in which the target device is held by a user, is considered. In such case, if the wireless communication device 100 and the target device are near each other, the wireless communication device 100 outputs the audio contents at a normal volume. Then, as the distance between the wireless communication device 100 and the target device become somewhere between short and long (i.e., middle), the audio is output by the wireless communication device 100 at increased volume. Here, if the distance between the wireless communication device 100 and the target device becomes long, the audio output by the wireless communication device 100 might not reach a user even if the volume is increased. Therefore, in such case, the wireless communication device 100 stops outputting the audio, and transmits audio data of the contents to the target device so as to make the target device to output the audio. Here, under the LE method, the audio data cannot be transmitted. Therefore, if the distance with respect to the target device becomes greater than the threshold 3, the wireless communication device 100 establishes a connection with the target device under the BR/EDR method to output the audio data. In the above, the processing in which the wireless communication device 100 mainly performs the operation is explained; however, the target device can mainly perform the processing. That is to say, if the distance between the target device and the wireless communication device 100 becomes greater than the threshold 3, the target device can send the connection request and the request for the audio data of the content via the BR/EDR, to the wireless communication device 100.

Here, instead of using a single control table, a number of control tables can be used. For example, a number of control tables corresponding to different types of application (application types) (e.g., an application for requesting output of the output information) and different types of output information (event types), can be used.

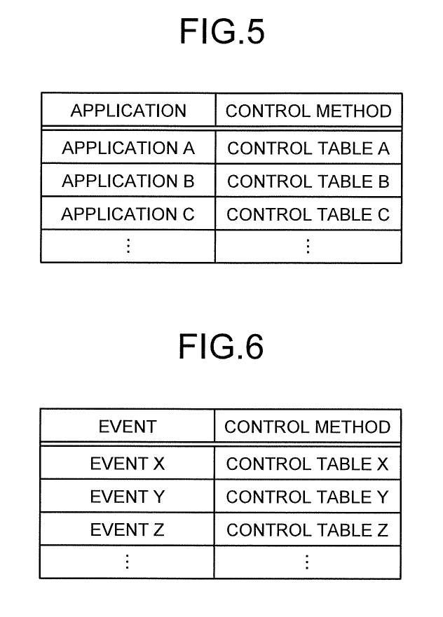

FIG. 5 is a diagram illustrating an example of a table for specifying a control table, where the table corresponds to the application type. FIG. 6 is a diagram illustrating one example of a table for specifying a control table, where the table corresponds to the event type.

FIG. 5 illustrates a case in which a control table A is used when the type of application is Application A, a control table B is used when the type of application is Application B, and a control table C is used when the type of application is Application C. For example, if the Application A is for video display and the Application B is for audio reproduction, the wireless communication device 100 can be configured to use either the control table A or B which differ from each other in threshold values in accordance with each property of the applications.

FIG. 6 illustrates a case in which a control table X is used when the type of event is Event X, a control table Y is used when the type of event is Event Y, and a control table Z is used when the type of event is Event Z.

Here, the wireless communication device 100 can be configured so as to use different control tables corresponding to combination of the type of application and the type of event. For example, a plurality of tables such as that of FIGS. 4 to 6 are combined together to specify a control method which corresponds to both the type of application and the type of event. Further, for example, the control method can be switched explicitly by a user via the operation module 150. Still further, settings of the table corresponding to the type of application and/or the type of event can be updated using the operation module 150.

The aforementioned detector 121, the communication controller 122, and the output controller 123 can be realized by, for example, executing a program stored in the storage module 110 and the like, i.e., by a software. Further, the detector 121, the communication controller 122, and the output controller 123 can be realized by, for example, a hardware such as an integrated circuit (IC). Still further, the detector 121, the communication controller 122, and the output controller 123 can be realized by, for example, both the software and the hardware.

The wireless communication devices 100a and 100b do not have to comprises the same configuration. For example, a portion of or all of the functions which are unnecessary for the following processing do not have to be provided. For example, if it is unnecessary to display information for a user, the display module 160 does not have to be provided. Further, if for example there exist other power supply sources, the battery 130 does not have to be provided.

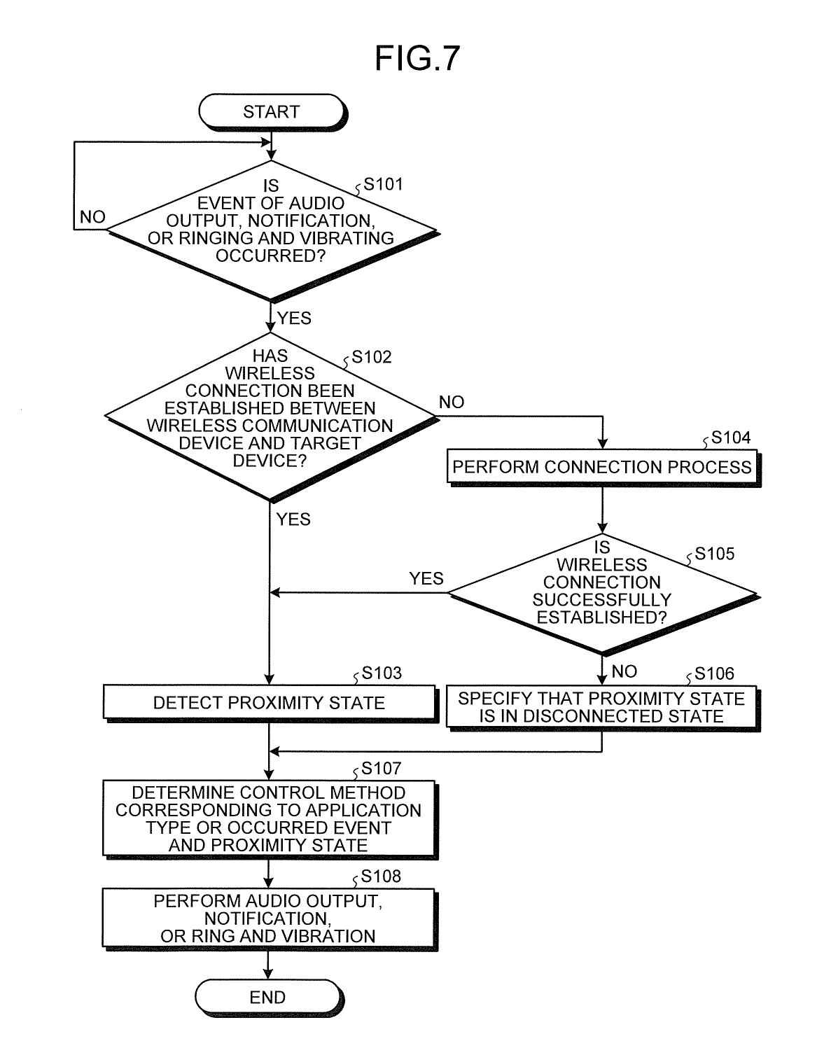

Next, with reference to FIG. 7, communication processing by the wireless communication device 100 according to the present embodiment as configured as above is explained. FIG. 7 is a flowchart illustrating an example of communication processing of the present embodiment.

The controller 120 determines whether an event such as the audio output, the notification, and/or the ringing and vibrating is occurred (S101) . If it is determined none of the event has occurred (No at S101), the wireless communication device 100 waits until some event occur.

When the event occurs (Yes at S101), the communication controller 122 determines whether the wireless connection with the target device has still been established (S102). If the wireless connection has not been established, i.e., if the communication with respect to the target device has been disconnected (No at S102), the communication controller 122 executes the processing for establishing the communication with the target device. Then, the communication controller 122 determines whether the wireless connection processing executed at S104 has successfully been performed (S105). If the wireless connection processing fails (No at S105), the detector 121 specifies that the proximity state is in the disconnected state (S106).

If it is determined at S102 that the wireless connection has been established (Yes at S102), and if it is determined at S105 that the wireless connection processing has successfully performed (Yes at S105), the detector 121 detects the proximity state with respect to the target device (S103).

After S103 and S106, the output controller 123 specifies the control method for the output information with reference to the control table as in FIG. 4, in accordance with the proximity state detected and specified (S107). At this time, the output controller 123 may refer to the specifying table such as that of FIGS. 5 and 6, to specify the control method by considering the type of application (application type) that had been executed when the event was occurred and the type of occurred event (event type).

The output controller 123 performs processing of actual audio output, notification, and ringing and vibrating, in accordance with the specified control method (S108). If the control method for outputting the output information from the target device is specified, the output controller 123 notifies the target device of the output request of the output information, for example, via the communication controller 122.

According to the processing, it can be capable of performing operations such as, for example:

(1) when there exists a user who holds the proximity notification device near the main device (wireless communication device 100), the notification sound by the main device such as reproduction of music, incoming ringtone, and an alarm is output at a normal volume;
(2) as the user moves away from the main device, the volume of the notification sound is increased; and
(3) when the user is at more than a certain distance away from the main device, the notification sound is notified at a side of the proximity notification device.
That is to say, convenience of the user can be enhanced by changing the state of the reproduction of music, the notification, and the ringing and vibration, in accordance with the proximity state.

In the above, it has been explained an example in which the proximity state is detected in view of a positional relationship between the wireless communication device 100 and the target device. However, the positional relationship to be detected is not limited thereto. For example, a position of the wireless communication device 100 and a position of the target device can be detected, and the control method for the output information can be switched in accordance with the relation between the detected positions.

In this case, the detector 121 further comprises a function for detecting the position of the wireless communication device 100 itself. The method for detecting the position can by arbitrary, and for example, a method that uses indoor global positioning system (GPS) technology such as the Indoor Messaging System (IMS) and a method that uses a wireless base station for measurement can be applied.

Further, the detector 121 detects the positional relationship between the wireless communication device 100 itself and the target device from a position of the wireless communication device 100 detected and a position of the target device received via for example the wireless communication module 140. For example, the detector 121 verifies the positions with predetermined map information of inside a room to detect whether there exist the wireless communication device 100 and the target device in the same room or in different rooms.

The output controller 123 switches the control method of the output information in accordance with the positional relationship detected, as described above. For example, if there exist the wireless communication device 100 and the target device in the same room, the output controller 123 can switch the control method in accordance with the proximity state, by using the method of the aforementioned embodiment. Further, for example, if there exist the wireless communication device 100 and the target device in different rooms, the output controller 123 may change the control method so as to output the output information at the side of the proximity notification device (target device) held by a user.

The positional relationship used to switch the control method can be any relationship as long as it represents a relationship between a position of the wireless communication device 100 and the external device. For example, a relationship such as: a direction from one of the wireless communication device 100 and the external device to other one of the wireless communication device 100 and the external device; similarity in height; similarity in posture; whether there exist a physical body such as obstacles between the wireless communication device 100 and the external device, may be used as the positional relationship.

As described above, the communication device according to the present embodiment can switch a device for outputting the output information and the control method defining the output method of the output information, etc., based on the positional relationship (proximity state). Consequently, it becomes capable to effectively output (notify of) the output information, thereby capable of enhancing the user's convenience.

The program executed in the communication device according to the present embodiment is provided as a computer program product in which the program is stored in a computer readable storage medium such as a compact disk read only memory (CD-ROM), a flexible disk (FD), a compact disk recordable (CD-R), a digital versatile disk (DVD), etc., in an installable or executable format.

Further, the program executed in the communication device according to the present embodiment may be configured such that the program is stored in a computer connected to the communication device via a network such as the Internet, and downloaded via the network, and provided. Further, the program executed in the communication device according to the present embodiment can be provided or distributed via the network such as the Internet.

Further, the program according to the present embodiment can be configured so as to be preliminarily be installed in a read only memory (ROM) and provided.

The program executed in the communication device according to the present embodiment comprises a module configuration comprising the aforementioned various modules. As an actual hardware, a central processing unit (CPU) reads out the program from the storage medium and executes the program. Accordingly, the aforementioned various modules are loaded on a main storage device, and the aforementioned modules are each generated on the main storage module.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A communication method performed by a communication device comprising an output module configured to output output information, the method comprising:
controlling communication between the communication device and an external device configured to output output information;
detecting a positional relationship between the communication device and the external device; and
switching, in accordance with the positional relationship, a processing to be performed from one of a first processing configured to output output information from the output module, a second processing configured to request the external device to output output information, and a third processing configured to output output information from the output module and to request the external device to output output information, to other one of the first processing, the second processing, and the third processing.

2. The communication method of claim 1, wherein
the detecting detects a proximity state of the communication device with respect to the external device, and
the switching switches the process from one of the first processing, the second processing, and the third processing to other one of the first processing, the second processing, and the third processing, in accordance with the proximity state.

3. The communication method of claim 2, wherein, if the proximity state indicates that a distance between the communication device and the external device is less than a first distance, the communication method performs the first processing.

4. The communication method of claim 2, wherein
the output information is information output as sound, and,
if the proximity state indicates that a distance between the communication device and the external device is greater than a second distance, the communication method outputs the output information at a volume larger than a volume of the output information output when the distance is less than the second distance.

5. The communication method of claim 2, wherein, if the proximity state indicates that a distance between the communication device and the external device is greater than a third distance, the communication method performs the second processing.

6. The communication method of claim 2, wherein, if the proximity state indicates that a distance between the communication device and the external device is greater than a fourth distance, the communication method performs none of the first processing, the second processing, and the third processing.

7. The communication method of claim 1, wherein the switching switches the process to be performed from one of the first processing, the second processing, and the third processing to other one of the first processing, the second processing, and the third processing, in accordance with the positional relationship and at least one of a type of a running application and a type of the output information.

8. A communication device comprising:
an output module configured to output output information;
a communication controller configured to control communication between the communication device and an external device configured to output output information;
a detector configured to detect a positional relationship between the communication device and the external device;
an output controller configured to switch, in accordance with the positional relationship, a processing to be performed from one of a first processing configured to output output information from the output module, a second processing configured to request the external device to output output information, and a third processing configured to output output information from the output module and to request the external device to output output information, to other one of the first processing, the second processing, and the third processing.

9. A computer program product having a non-transitory computer readable medium including programmed instructions, wherein the instructions, when executed by a computer, cause the computer to perform:
controlling communication between the communication device and an external device configured to output output information;
detecting a positional relationship between the communication device and the external device; and
switching, in accordance with the positional relationship, a processing to be performed from one of a first processing configured to output output information from the output module, a second processing configured to request the external device to output output information, and a third processing configured to output output information from the output module and to request the external device to output output information, to other one of the first processing, the second processing, and the third processing.
